(19) United States
(12) Patent Application Publication
(10) Pub. No.: US 2009/0063196 A1
(43) Pub. Date: Mar. 5, 2009

(54) SYSTEM AND METHOD OF DENTAL CASE MANAGEMENT

(75) Inventor: Kelly Frederickson, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: DDS Ventures, Inc., San Diego, CA (US)

(21) Appl. No.: 12/199,709

(22) Filed: Aug. 27, 2008

Related U.S. Application Data
(60) Provisional application No. 60/968,513, filed on Aug. 28, 2007.

(51) Int. Cl. G06Q 50/00

(52) U.S. Cl. 705/3

(57) ABSTRACT

A system and method of case management is disclosed. In one embodiment, a method of managing dental cases is disclosed, the method comprising storing in a data storage, user information indicative of a plurality of users, storing in the data storage, patient information indicative of a plurality of dental patients to which access is granted to at least one of the users, storing in the data storage, case information indicative of a plurality of dental cases, each dental case relating to a single dental patient and to which access is granted to selected ones of the users, identifying a computer as being associated with a particular user, and, in response to a request from a computer identified as being associated with a particular user, transmitting information in the data storage to the computer to which access is granted to the particular user.

### CROSS-REFERENCE TO RELATED APPLICATIONS

This application claims the benefit under 35 U.S.C. 119(e) of U.S. Provisional Application No. 60/968,513, filed on Aug. 28, 2007, the disclosure of which is incorporated herein by reference in its entirety.

### BACKGROUND

1. Field

The present invention relates to case management systems, and in particular, to web-based case management systems.

2. Description of the Related Technology

Typically, in the dental field, a patient of a general dentist may have a problem that requires the patient to be seen by a specialist in the field, e.g., an orthodontist or dental surgeon. In such an instance, the general dentist will issue a referral which can be communicated in a number of ways. The general dentist may simply recommend a particular specialist with whom the patient makes an appointment, telling the specialist that he/she was referred by their general dentist. Alternatively, the general dentist may transmit via fax or mail a referral letter to the specialist to introduce the patient, request the services of the specialist for the patient, and possibly explain some of the details of the case, e.g., why the services of the specialist are needed.

In either case, the specialist may or may not follow up with the general dentist to let him/her know that the referral was made, and that the services were performed. Information, such as patient allergies or relevant dental history may not be communicated. This problem can be compounded when there are several dentists, specialists, or dental laboratories involved in the same case, or with the same patient.

### SUMMARY OF CERTAIN INVENTIVE ASPECTS

One aspect of the invention is a method of managing dental cases comprising storing in a data storage, user information indicative of a plurality of users, storing in the data storage, patient information indicative of a plurality of dental patients to which access is granted to at least one of the users, storing in the data storage, case information indicative of a plurality of dental cases, each dental case relating to a single dental patient and to which access is granted to selected ones of the users, identifying a computer as being associated with a particular user, and in response to a request from the computer identified as being associated with a particular user, transmitting information in the data storage to the computer to which access is granted to the particular user.

Another aspect of the invention is a dental case management system comprising a database of information comprising user information indicative of a plurality of users, dental patient information indicative of a plurality of dental patients, to which access is granted to at least one of the users, case information indicative of a plurality of dental cases, each dental case relating to a single patient and to which access is granted to selected ones of the users, software executed by a processor for identifying a computer as being associated with a particular user, and providing access to database information to which access is granted to the particular user.

Yet another aspect of the invention is a program storage device storing instructions that when executed perform a method of managing cases, the method comprising storing user information indicative of a plurality of users, storing patient information indicative of a plurality of patients, storing case information indicative of a plurality of cases, each case relating to a single patient and selected ones of the users, storing permissions information indicative of a plurality of permissions, each permission being associated with a selected one of the users and at least a portion of the patient information or case information, identifying a computer as being associated with a particular user, and, in response to a request from a computer identified as being associated with a particular user, transmitting particular information in the database for which a permission is stored associated with the particular user and the particular information.

Still another aspect of the invention is a case management system comprising means for storing user information indicative of a plurality of users, means for storing patient information indicative of a plurality of patients to which access is granted to a selected one of the users, means for storing case information indicative of a plurality of cases, each case relating to a single patient and to which access is granted to selected ones of the users, means for indentifying a computer as being associated with a particular user, and means for, in response to a request from the computer identified as being associated with a particular user, transmitting information to which access is granted to the particular user.

### BRIEF DESCRIPTION OF THE DRAWINGS

FIG. 1A is a functional block diagram of a web-based case management system.

FIG. 1B is a functional block diagram of a server in a web-based case management system.

FIG. 2 is an exemplary screenshot of the landing page.

FIG. 3 is an exemplary screenshot of a case manager.

FIG. 4 is an exemplary screenshot of a list of patient collaboration folders.

FIG. 5 is an exemplary screenshot of a patient collaboration folder.

FIG. 6 is an exemplary screenshot of a patient collaboration folder creation page.

FIG. 7 is an exemplary screenshot of a case file.

FIG. 8 is an exemplary screenshot of a messaging center.

FIG. 9 is an exemplary screenshot of a report generation page.

FIG. 10 is an exemplary screenshot of a referral network listing.

FIG. 11 is a flowchart illustrating a method of managing cases.

### DETAILED DESCRIPTION OF CERTAIN INVENTIVE EMBODIMENTS

While embodiments of the invention have been designed primarily for use in the dental industry by dental practitioners, it will be understood that the teachings of the invention are equally applicable to a variety of other industries and businesses, as will be described later. Herein follows a detailed description of a specific embodiment relating to a web-based dental case management system.

Embodiments of the invention generally allow for communication of patient information between dental practitioners over a network, streamlining and standardizing the referral process. Some inventive aspects relate to a system (the so-called ddsWebLink system) to manage the dental referral process and case management workflow over an Internet connection, consequently building a massive online community of dental professionals. The system may allow dentists to manage their entire referral process online, manage patient cases, and eliminate the costly paper trail. It may mimic current elements of the offline referral process, thus providing users with a system that will improve their overall communication and productivity.

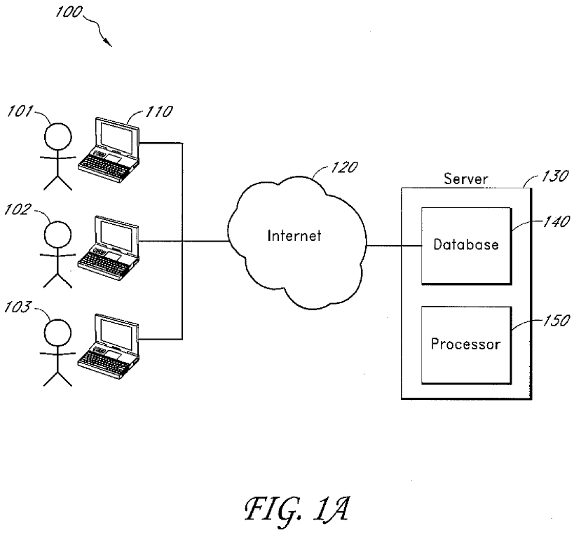

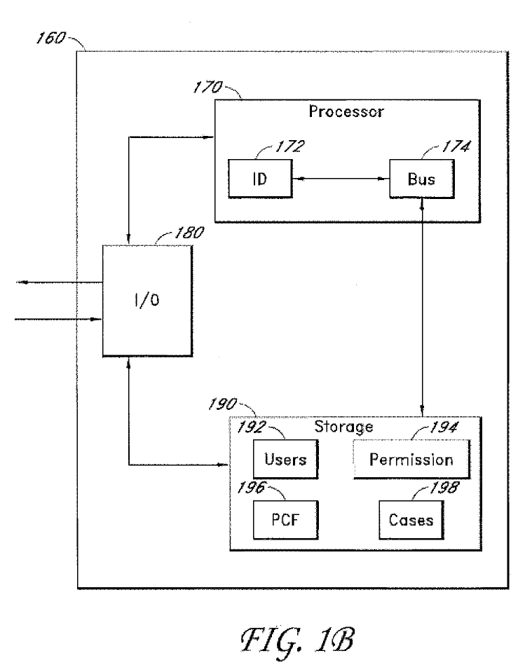

FIG. 1A is a functional block diagram of a web-based case management system. The system 100 comprises a server 130 accessed by a number of users 101, 102, 103 over a network 120. The server may comprise, among other things, a database 140 and a processer 150, and is further described below with respect to the specific embodiment shown in FIG. 1B. Users 101, 102, 103 access the server 130 over a network 120, such as any combination of one or more LANs, WANs, or the Internet, for example, via a wired connection, wireless connection, or combination of wired and wireless connections. The network may communicate with various computing devices and/or other electronic devices via wired or wireless communication links. For example, a data stream may be received from a network 120 and comprise data, such as web or email data, for example, transmitted by the users 101, 102, 103 from one or more access computers 110 across the Internet.

One type of data which may be stored in the database 140 is a patient collaboration folder (PCF), which is, conceptually, a folder containing basic patient information and a collection of all cases associated with a particular patient. Another type of data which may be stored in the database 140 is a case file, which is conceptually stored within a patient collaboration folder and which contains information regarding a single case, such as a single referral or a lab script. A case typically has two case partners, the referrer and the referee. Other embodiments of the invention may allow for cases with different numbers of case partners, such as during a particularly complicated procedure. In practice, the PCF may be a data file or collection of data files stored in the database 140, which comprise data indicative of basic patient information such as patient name, address, phone number, insurance billing information, medical history, allergies, etc. The PCF may further comprise data indicative of other data files corresponding to particular cases. For example, the PCF may comprise data indicative of a case ID number corresponding to a case associated with the patient with which the PCF is associated. Both the PCF and the case files may comprise links to uploaded documents or images associated with the patient or the case.

As one embodiment of the invention is a subscriber-based system, it is important to realize that the system may be accessed by a number of different types of users, including an account subscriber 101 such as a dentist, dental specialist, or lab clinician with full administrative privileges within a dental practice or dental laboratory who has completed an account registration process for full system membership and site privileges. The account may be legally registered to the business entity that this user 101 represents. Other users of the system may include an account admin user 102, such as an office staff member, office manager, lab employee, etc., who operates under the system membership of an account subscriber 101. In some embodiments, this user 102 may have full access to all of the account settings, including the ability to create addition users. Other users may include a regular account user 103 such as an office staff member, office manager, lab employee, etc. who operates under the system membership of an account subscriber 101, but has limited account setting access. Another embodiment of the invention allows for a non-member, i.e. a guest user, to be directed to the log-in page through the case management process and to complete a “Guest Access” page using a Referral or Lab Script case ID number.

In one embodiment of the invention, all PCFs can be viewed and edited by anyone registered in the ddsWebLink system; however, individual cases within a PCF can only be viewed by the case partners (or subscribers who have been granted access) and can only be edited by the case originator. In other embodiments of the invention, access and modification rights distribution may differ. For example, in one embodiment, although PCFs can be viewed by all users, they may only be edited by the originator. Access and modification rights preferably respect the privacy of the patient and conform to government standards. In some embodiments of the system, cases may be linked together. For example, a first case may be originated by a general practitioner referring the patient to a specialist for a tooth extraction. The specialist may determine that the tooth is dangerously close to the sinus cavity and may generate a second case further referring the patient to a dental surgeon for extraction of the tooth. The first and second case can be linked and all three dental professionals (the general practitioner, the specialist, and the dental surgeon) may have access to any X-rays or notes regarding the case(s).

FIG. 1B is a functional block diagram of a server in a web-based case management system according to one embodiment of the invention. The server 160 comprises three modules including a processing module 170, and input/output module 180, and a storage module 190. The input/output module 180 connects to the processing module 170 and the storage module 190 and enables communication of data from and to the system. The input/output module may be responsible for parsing or formatting data into a form for processing by the processing module.

In the embodiment of FIG. 1B, the processing module 170 comprises two sub-modules including an identification module 172 and a bus 174. The identification module 172 is responsible for identifying a computer as being associated with a particular user. This may be accomplished by comparing a username and password with one stored in the storage 190, or by communicating with an authentication server remotely located from the server 160. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a conventional single- or multi-chip processor such as a Pentium® processor, Pentium II® processor, Pentium III® processor, Pentium IV® processor, Pentium® Pro processor, a 8051 processor, a MIPS® processor, a Power PC® processor, or an ALPHA® processor. The processing module 170 may also be controller, microcontroller, or state machine. The processing module 170 may also be implemented as a combination of computing devices, e.g., a combination of a DSP and a microprocessor, a plurality of microprocessors, one or more microprocessors in conjunction with a DSP core, or any other such configuration. The processing module 170 is coupled to the storage module 190 via a bus 174. The bus 174, similar to the input/output module 180, may be responsible for parsing or formatting data such that data sent from the processing module 170 is in a form more appropriate for the storage module 190 or vice versa. This may include compression/decompression, coding/decoding, or encryption/decryption.

The storage module 190 is configured to store data and embodies electronic circuitry that allows information, which is typically computer data, to be stored and retrieved. The storage module may also include external devices or systems such as, for example, disk drives or tape drives. The storage module 190 may include RAM memory, flash memory, ROM memory, EPROM memory, EEPROM memory, registers, hard disk, a removable disk, a CD-ROM, or any other form of storage medium known in the art. An exemplary storage medium is connected to the processor such the processor can read information from, and write information to, the storage medium. In the alternative, the storage medium may be integral to the processor. For example, the processing module 170 and the storage module 190 may reside in an ASIC or in any suitable commercially available chipset.

The storage module 190 comprises a number of submodules, including a user module 192, a permissions module 194, a patient collaboration folder (PCF) module 196, and a case module 198. The user module 192 stores, among other things, information indicative of a plurality of users, e.g. the users 101, 102, 103 shown in FIG. 1A. The information may include name, contact information, billing information, etc. The user module 192 may also store a username and password associated with each user for use by the identification module 172. The permissions module 194 stores information indicative of which users are granted access to which information within the storage module 190, including patient information within the PCF module 196 and case information in the case module 198. Permissions may be stored, for example, as an association between information indicative of a particular user in the user module 192 and information indicative of a particular case in the case module 198. There may be different classes of permissions, such as read-only, read-write, read-write-delete, etc. Permissions may also be stored within the user module 192, PCF module 196, or case module 198 directly.

The server 160 is generally controlled and coordinated by server and/or desktop computer operating system software, such as the Windows 95, 98, NT, 2000, XP, Vista, Linux, SunOS, Solaris, PalmOS, Blackberry OS, or other compatible operating systems. In Macintosh systems, the operating system may be any available operating system, such as MAC OS X. In other embodiments, the server 130 may be controlled by a proprietary operating system. Conventional operating systems control and schedule computer processes for execution, perform memory management, provide file system, networking, and I/O services, and provide a user interface, such as a graphical user interface (“GUI”), among other things.

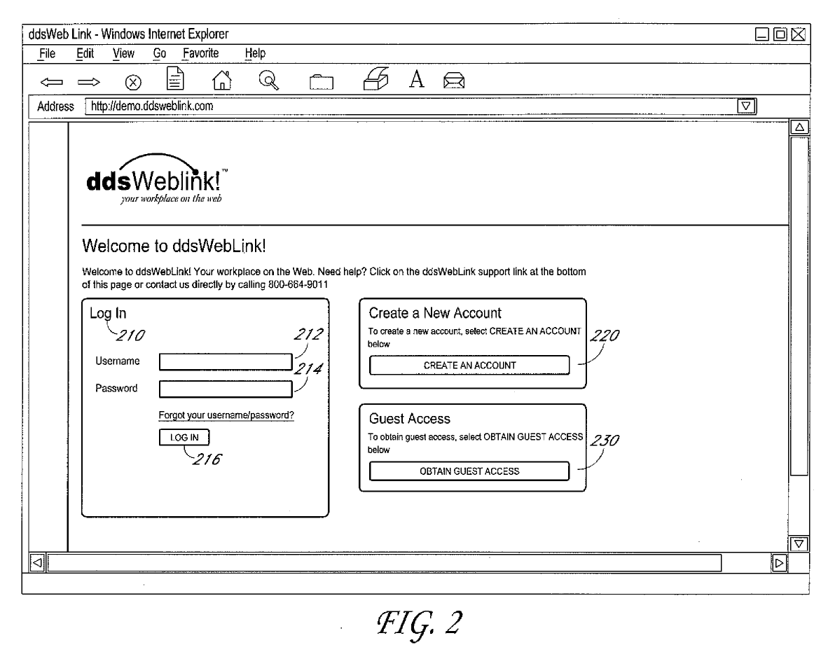

FIG. 2 is an exemplary screenshot of the landing page according to one embodiment of the invention. The landing page may be designed to serve as the primary point of entry into the ddsWebLink system. Some embodiments of the invention may include login functionality 210, including a username field 212, a password field 214, and a login button 216, an account creation button 220, and a guest access button 230. As the primary point of entry into the ddsWebLink system, the landing page includes login functionality 210. To log in, the user may enter a username into the username field 212, enter a password into the password field 214, and click the login button 216. The username and password are transmitted to a server, e.g., over the network 120 to the server 130 of FIG. 1, which ensures that the username and password match a username/password combination in the database 140. If a match is found, the user is allowed to enter the system and access the information to which access has been granted to the user. The landing page may also include the option of creating a new account via the account creation button 220. The landing page may also include the option of obtaining guest access privileges via the guest access button 230.

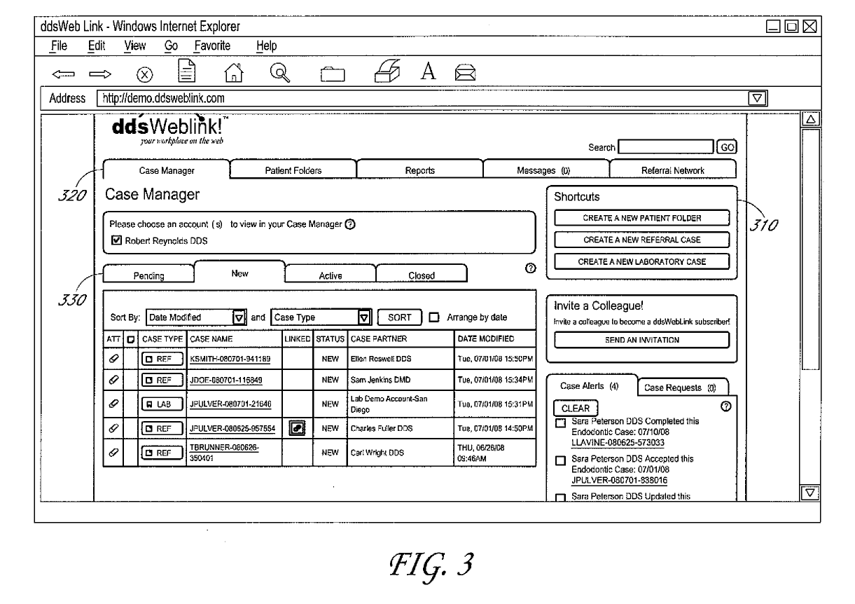

Upon logging in, the user may be, according to an embodiment of the invention, directed to a case manager. FIG. 3 is an exemplary screenshot of a case manager according to one embodiment of the invention. The case manager is where users will be able to collaborate with other ddsWebLink members via case referrals. In some embodiments of the invention, the case manager is dynamic, with security and access considerations applied against various users. Components of this area may be linked to other site areas and vice versa via shortcuts 310 or metatabs 320. Access and management privileges may differ between dental practices and dental laboratories. In some embodiments, the case manager is the primary interface for viewing cases. Various types of information about particular cases may be displayed, including a case type, a case name, a status of the case, the case partners, and the date the case was most recently modified. Dynamic sorting functionality may be present in the case manager. The cases may also be sorted through the use of one or more tabs 330. In one embodiment of the invention, the cases are sorted into four tabs 330 including: pending cases, new cases, active cases, and closed cases.

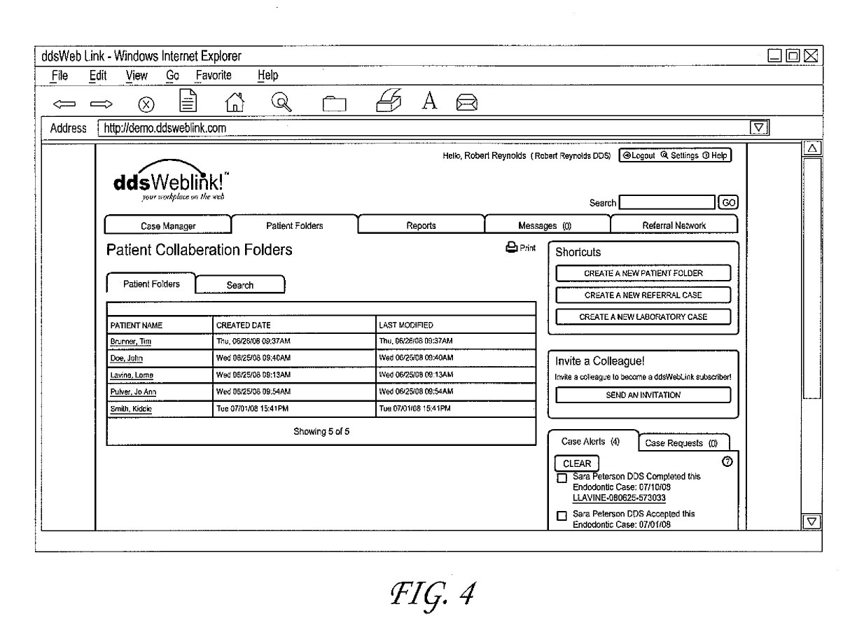

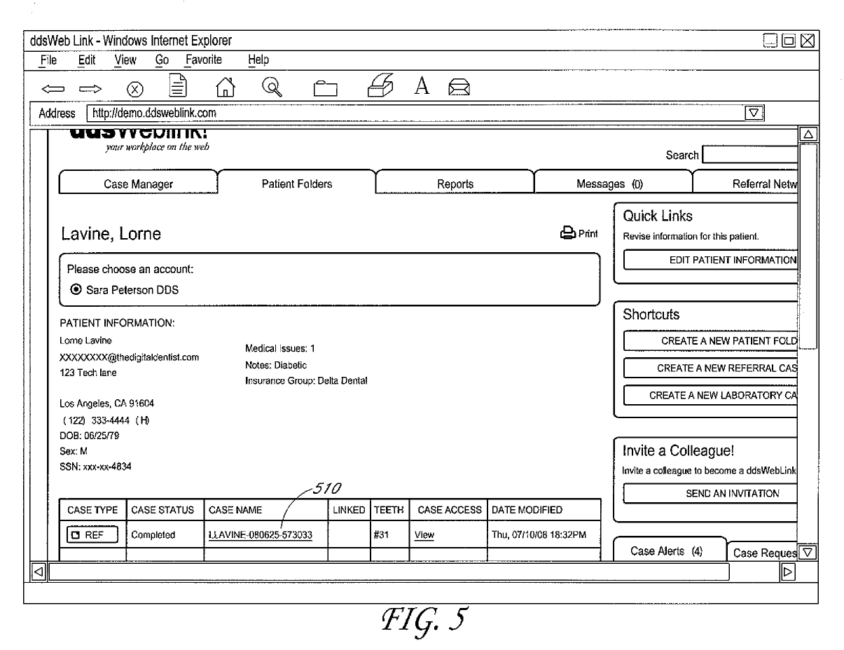

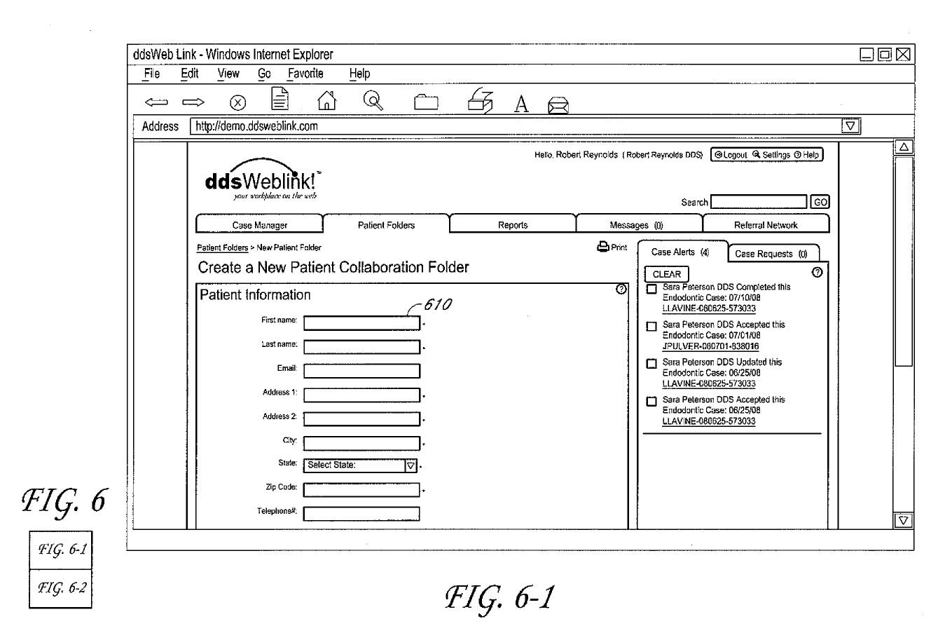

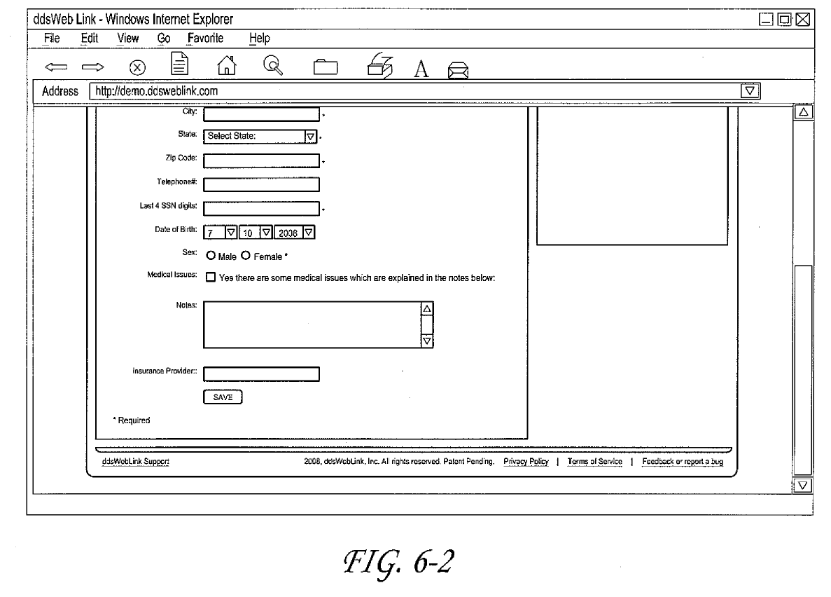

In certain subscription-based embodiments, each user of the system is associated with a subscription associated with a licensed dental professional or laboratory. Some embodiments of the system allow a user of the system to list the patients with which the account has some association with, e.g. via referral. FIG. 4 is an exemplary screenshot of such a list of patients linking to the respective patient collaboration folder. FIG. 5 is an exemplary screenshot of a patient collaboration folder. As mentioned above, in practice, a patient collaboration folder is a file or collection of files storing data indicative of patient information in a database. Alternatively, the patient collaboration folder may be considered a webpage displaying the information stored in the file or collection of files. Each patient collaboration folder may advantageously contain links 510 to each case associated with the patient. The link may be enabled or disabled depending on the access rights of the user viewing the PCF. As mentioned previously, access to patient collaboration folders and case files is dependent on access rights granted to particular users of the system. In some embodiments, PCFs may be viewed and edited by any user of the system. In other embodiments, PCFs may be viewed by any user of the system, but only edited by the creator of the PCF or someone to whom that right has been assigned, e.g, by the creator of the PCF or a system administrator. In still other embodiments, PCFs may only be viewed and/or edited by specific users to which that right has been granted. FIG. 6 is an exemplary screenshot of a patient collaboration folder creation page. To create a new patient collaboration folder, information is input into various fields 610, including last name, first name, address, phone number, social security number, date of birth, and gender. Specific medical issues, such as high blood pressure or the presence of a pacemaker may also be entered. Insurance information for the patient may be included in a patient collaboration folder. The patient collaboration folder may also include additional notes about the patient.

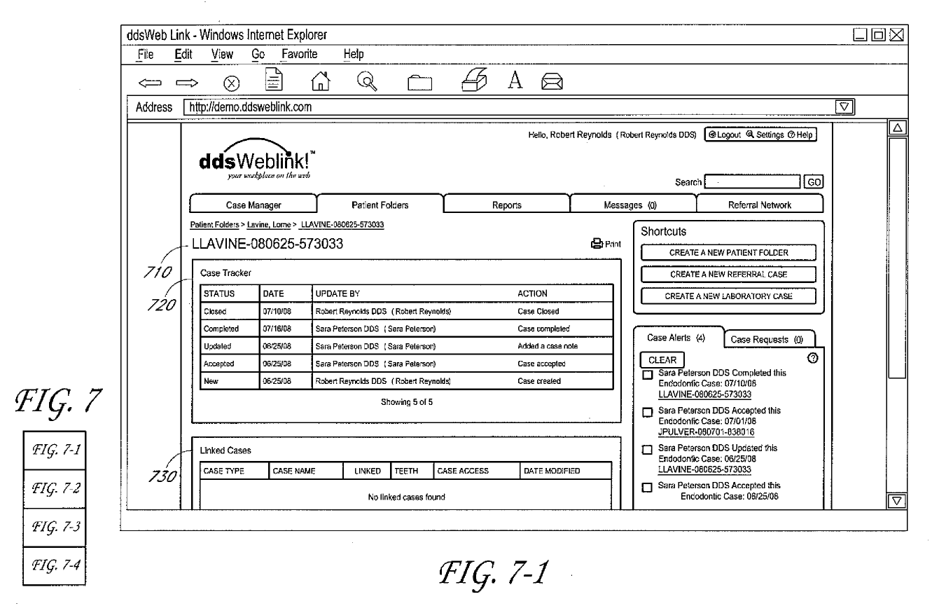

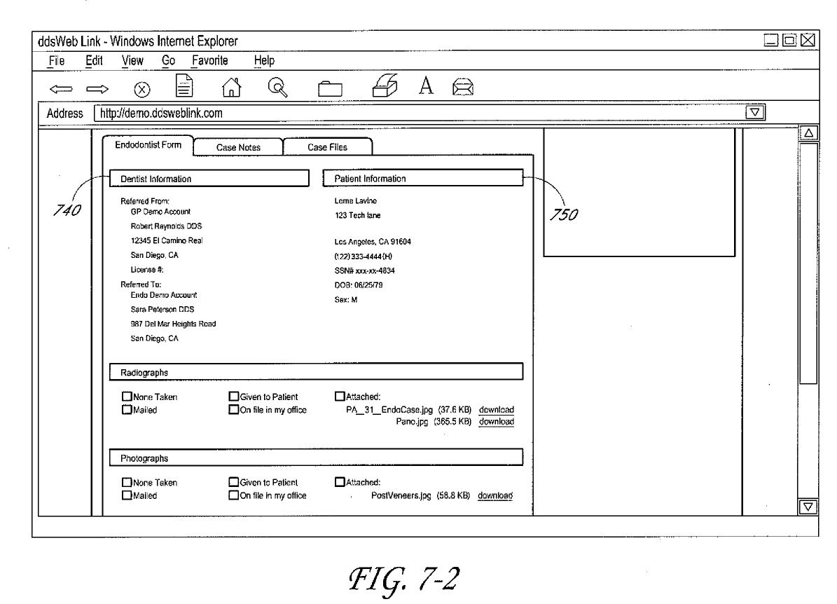

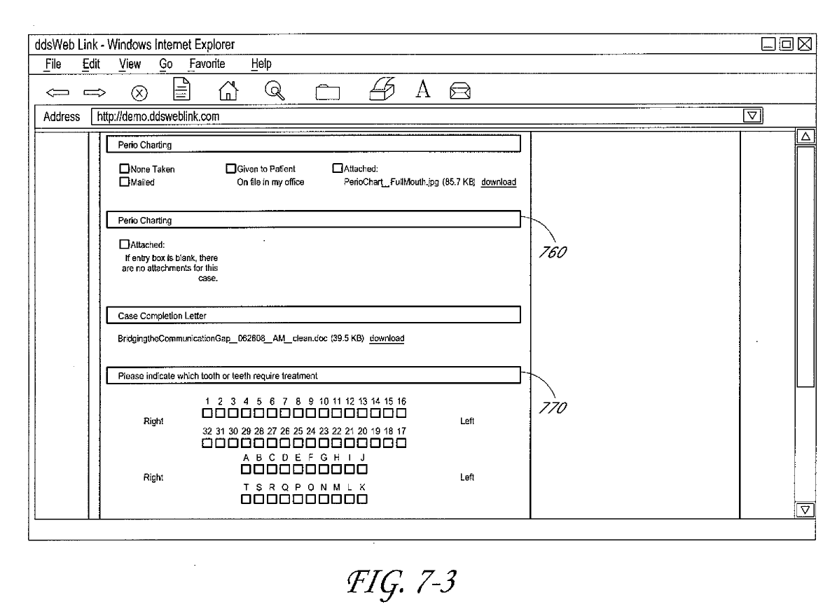

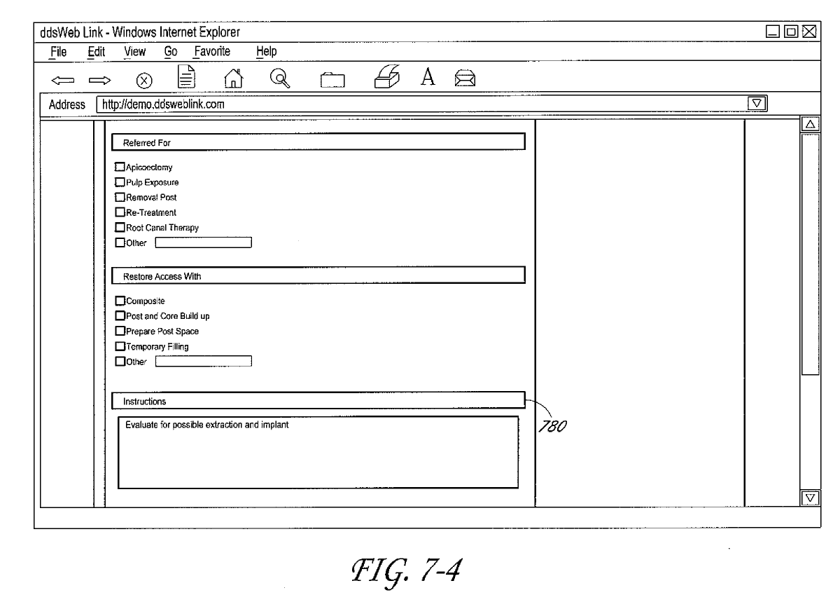

FIG. 7 is an exemplary screenshot of a case file. Displaying each case may involve displaying information in the database associated with a case. For example, the case name 710 may be displayed. In some embodiments, each case is given a unique identifier, such as an alphanumeric string to differentiate it from other cases within the database, and to facilitate linking case information to patient information in a patient collaboration folder. A case tracker 720 section may advantageous show the status of the case, when and who it was updated by, and what action has been taken on the case. The display of a case may also comprise displaying linked cases 730. Linked cases can allow an arbitrary number of ddsWebLink users to have access to any X-rays or notes regarding the case(s). The display of a case may also include the display of dentist information 740 of the parties involved in the case, as well as patient information 750. Notes regarding attachments 760 to the case, such as documents or images may also be displayed as part of the case. Check-boxes may also be present to indicate which tooth/teeth needs treatment via a tooth selection chart 770. The tooth selection chart may take many forms, including graphical. Instructions 780 concerning the case may also be present.

In managing a case or a patient collaboration folder, users with appropriate permissions may be able to grant access to other users, request or provide a consultation, make status changes, attach files such as X-rays, documents, or other images, view referral forms for all dentist types and specialties, create a new referral or lab case, set alerts, indicate which practice location lab work should be sent to, run reports, print any case, or save any case in the system.

Additional functionality may be included in the ddsWebLink system including messaging, report generation, and referral network listing. FIG. 8 is an exemplary screenshot of a messaging center. The system may have an internal messaging function that will allow users to communicate with each other in several fashions. Although the messaging system resides, in some embodiments, within the ddsWebLink system, user preferences may dictate how these messaging functions will extend out of the system. Messaging functionality includes user-to-user communications which are not case/patient specific, office-wide communication, and new member invitations. Messaging may also include user-to-patient communications.

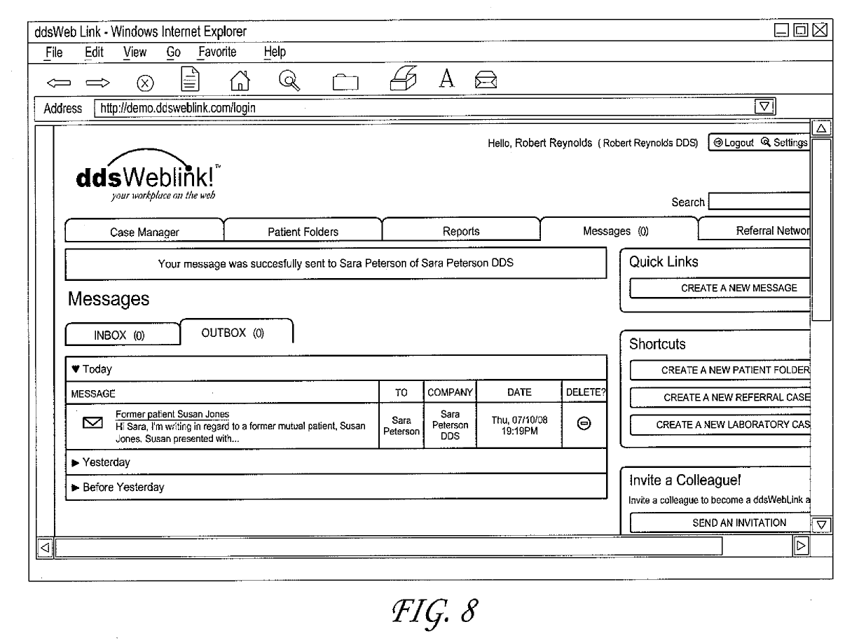

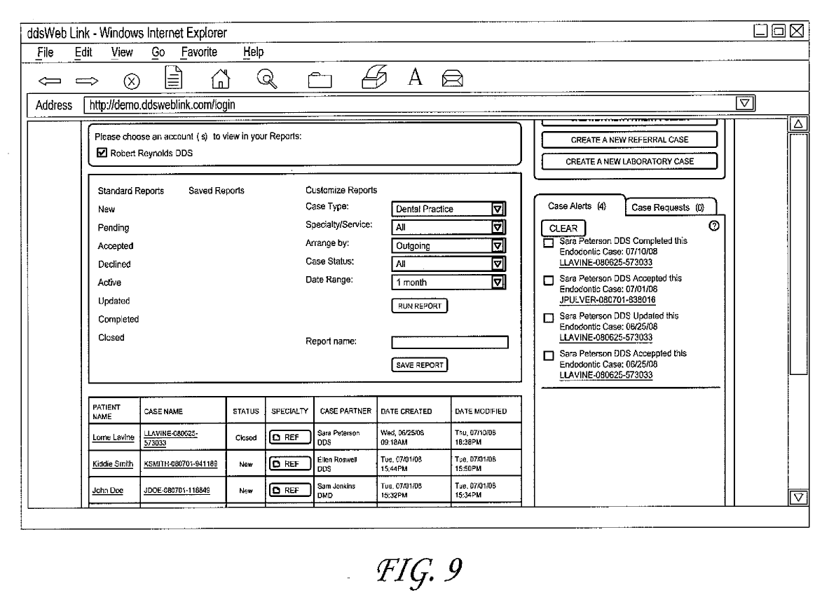

FIG. 9 is an exemplary screenshot of a report generation page. The ability to report on the status of referrals/lab scripts throughout the process may be an advantageous part of the system. This may allow users to have an offline record of referrals/lab scripts and other paperwork (generated from the system). Offices may have the ability to reconcile referrals/labs scripts and to better manage the process with reporting functionality. Reports may be created concerning a single case, a single patient collaboration folder, a service provided, or other information. Reports may be arranged by a number of criteria including case status or date. The system may also have the ability to save reports, or to save the criteria for running the report at a later time.

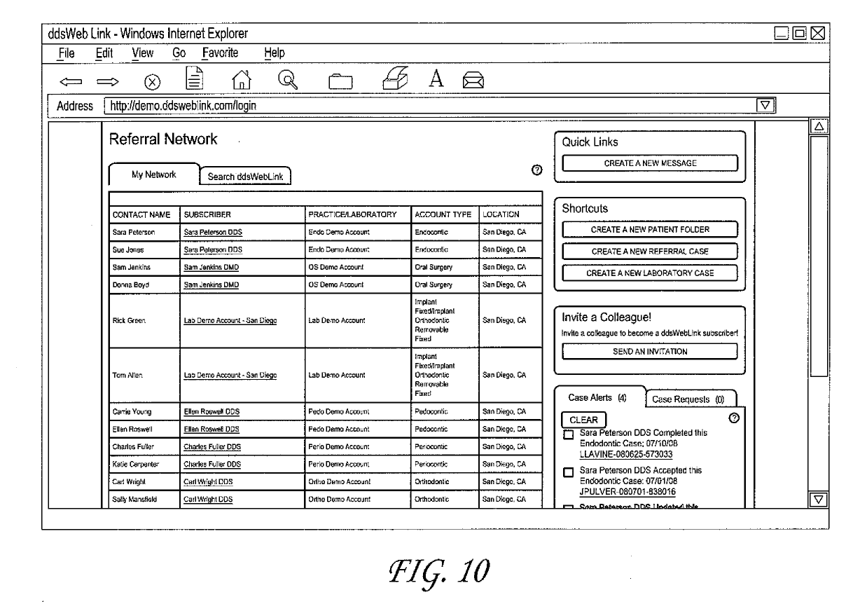

FIG. 10 is an exemplary screenshot of a referral network listing. Through the referral network page, users may be able to access and expand their network through a contact list and directory, as well as initiate referrals and lab scripts. The referral network page serves a number of purposes including locating other dentists, specialists, or laboratories to add to one's network, and inviting non-ddsWebLink users to join.

Although the above description has been directed to embodiments concerning dental case management, similar applicability and utility may be found in a variety of other industries and businesses. Some such applications are detailed below.

A medical case referral management system could be used by medical practitioners. Doctors of all types, including general practitioners, specialists, surgeons, psychiatrists, psychologists, other medical practitioners and the professionals providing case related services at laboratories, imaging centers, physical therapy centers, hospitals, and other patient case facilities have a similar need to collaborate on patient treatment plans and share confidential patient files. Further, all of these practitioners are subject to the same HIPAA regulations governing the confidentiality of patient information and the need for a secure method of permission-based collaboration and file sharing. The described system enables this collaboration and file sharing in a convenient, secure manner consistent with governmental regulations.

Doctors in medical schools, dentists in dental schools, and their respective students likewise need to collaborate over patient cases being used for instructional purposes. Sometimes these cases involve real people currently seeking medical treatment and willing to be used for instructional purposes in exchange for the treatment. In these cases, HIPAA regulations also apply. Other teaching cases may be fictitious and use archived information and images. Irrespective of whether the patient is real or fictitious, students and teachers must collaborate and have access to image and information files for instruction and the development of student recommended treatment plans and procedures. The invention enables this collaboration and file sharing in a convenient, secure manner.

Hospital applications are also possible. When doctors or dentists collaborate and share files with their colleagues or other professionals providing case-related services, the collaboration is most often with someone in a different physical location and in some cases thousands of miles away. The described system can enable this collaboration and file sharing in a convenient, secure manner consistent with the requirements of HIPAA. HIPAA requirements also apply to the manner in which patient information is shared in a hospital environment where the collaborators are often on the same premises, but perhaps accessing the information at different times. Specialists are consulted, images taken, lab tests run, procedures done, and in-patients constantly monitored. This means that patient files must be available to those who need them when they are needed, even if it is from home in the middle of the night when a patient emergency arises. The described system can enable this collaboration and file sharing both within the hospital environment as well as from remote locations.

Although above-described embodiments of the invention have primarily focused on medical or dental fields, other applications are possible. For example, various social services agencies must collaborate and share case file information for efficiency, information sharing, case tracking, quality of service, and compliance with various legal and regulatory requirements. A single case can involve several different agencies and while many of these agencies are not typically subject to HIPAA, state and local laws generally prescribe a high level of confidentiality and security of case information. This is particularly true in child welfare cases where as many as twenty different agencies may have reason to collaborate in the management and disposition of a case. Failure to properly manage or supervise a case can mean that a child might be placed or left in an abusive home, emotional or physical needs might go unmet or warning signs of dangerous anti-social behavior might be missed. The described system can enable various social services agencies to collaborate in case management by accessing and contributing to individual case files in a convenient, secure and confidential manner and to be alerted by other agencies when particular services are needed in any given case. A permission-based system of collaboration and notifications reduces case errors, keeps individuals from falling through the bureaucratic cracks and leaves audit trails that clearly indicate who knew or should have known, what was or should have been done, who notified or should have notified whom, and generally what occurred, when and where.

Designers, builders and approvers of large, complex commercial and industrial projects have a need to collaborate extensively and share files throughout the project. Architects are the creative force but their creativity must be applied within the limits of what engineers say is feasible, what contractors say can be done given the budget and what local building codes, zoning and plans allow. The described system can make this whole process more efficient from start to finish by allowing all parties involved to collaborate and share files during the planning and construction process, while protecting the potential trade secrets of the interested parties. The described system can enable architects to open project folders and store files such as conceptual drawings and prints online and grant permission to local planning agencies and engineers to comment. Similarly, blueprint files can be stored in the project folder and permission granted to engineers and building contractors to review them for technical problems, projected costs, and real world feasibility. The described system can allow municipal planning departments to be granted permission to review files during the planning process to ensure that the project scope, design and plan are within local master plans, comply with city ordinances and do not violate local building codes. Throughout the whole process collaboration and file sharing is done in a secure environment where data input from all parties is kept indefinitely for later review thereby leaving an audit trail for those occasions when cost overruns occur because something has to be changed or redone.

Professionals besides doctors and dentist may also benefit from embodiments of the system. Lawyers, too, frequently have a need to collaborate on cases and share case files in a secure and confidential manner. Sometimes it is a single lawyer in need of specialized expertise. Sometimes, it is two or more lawyers representing opposing parties seeking a resolution to a legal matter. Sometimes, it is multiple firms working in concert on a large class action matter. Irrespective of whether it is two lawyers collaborating on a single case file or multiple firms collaborating on a class action lawsuit, collaboration and file sharing must be done in a discreet and secure manner that ensures access to information is restricted to only those who have a right or need to see it. E-mailing Word or Acrobat documents is not secure as an email can be misaddressed or even intercepted. Mail or courier can be more secure but it is also slow. A secure way for lawyers to collaborate and share files is to store case files in a secure online environment that grants access only to those individuals who have been granted permission to see them. The described system may allow lawyers to efficiently collaborate and share privileged information in an environment that ensures only those individuals with a right or need to know will have access to the information.

Although specific embodiments have been discussed in detail, other applications of the described system are possible, and the described system may have application and utility in many other business, non-profit or government organizations that need an efficient, convenient, secure way to collaborate and share files, including the military, law enforcement, intelligence and homeland security agencies. Other branches of federal, state and local governments may also have a need to collaborate and share data in a secure environment where access is restricted to only those who have been granted permission. Large accounting firms would find the described system's secure file sharing and collaboration features useful for the same reasons law firms will find it useful. Research organizations that wish to collaborate and share information with colleagues around the world could most certainly benefit from the described system's permission based collaboration and secure file sharing features.

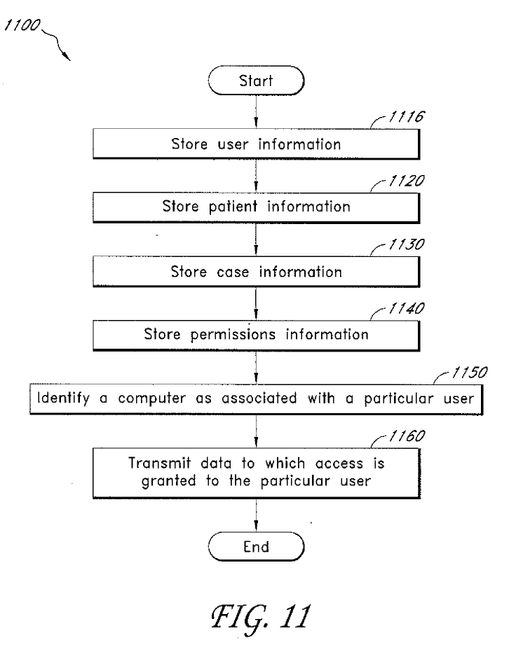

FIG. 11 is a flowchart illustrating a method of managing cases. The process 1100 begins, in block 1110, by storing user information indicative of a plurality of users. As discussed above storing may be done in a storage module or a database. User information may include date, contact information, billing information, etc. The users may be account subscribers, account administration users, or regular account users, and may further be dentists, dental specialists, lab clinicians, doctors, lawyers, teachers, students, or other professionals.

In block 1120, patient information indicative of a plurality of patients is stored. Access to the patient information, as described below with respect to block 1140, is granted to at least one user, e.g., the user who inputted the patient information. Alternatively, access to the patient information is granted to the plurality of users, that is, the patient information is freely accessible by any subscriber to the system.

In block 1130, case information indicative of a plurality of cases is stored. Each case relates to a single patient and at least two users, e.g. case partners, as described in detail above. Access to the case information, as described below with respect to block 1140, is granted to at least two users, e.g., the case partners. Alternatively, access may be granted to the case to other users for consultation or other purposes.

In block 1140, permissions information indicative of a plurality of permissions is stored. Each permission is associated with a user and at least a portion of the patient information or case information. For example, a particular user may have a permissions list indicative to which patient information and case information the user is granted access. Alternatively, each portion of patient or case information may have a permissions list indicating to which users access is granted.

In block 1150, a computer is identified as being associated with a particular user. As described above, this may be done with a username/password authentication. Other forms of identification, such as biometric scanning may also be used to identify a computer, remote from the server, as being associated with a particular user.

In block 1160, in response to a request from a computer identified as being associated with a particular user, particular information in the database is transmitted for which a permission is stored associated with the particular user and the particular information. Thus, a server, such as the server shown in FIG. 1, may receive a request from a computer identified as being associated with a particular user for case information related to a particular case. The server checks the permissions information to see if there exists a permission granting access to the case information to the particular user. If so, the server transmits the information to the computer associated with the particular user.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of managing dental cases comprising:
storing in a data storage, user information indicative of a plurality of users;
storing in the data storage, patient information indicative of a plurality of dental patients to which access is granted to at least one of the users;
storing in the data storage, case information indicative of a plurality of dental cases, each dental case relating to a single dental patient and to which access is granted to selected ones of the users;
identifying a computer as being associated with a particular user; and
in response to a request from the computer identified as being associated with a particular user, transmitting information in the data storage to the computer to which access is granted to the particular user.

2. The method of claim 1, wherein the transmitted information refers to a single patient.

3. The method of claim 2, wherein the transmitted information is indicative of a single case.

4. The method of claim 1, further comprising:
storing in the database, message information, indicative of a plurality of messages, each message created by a single user and to which access is granted to at least two users.

5. The method of claim 1, further comprising:
granting access to selected user information to a plurality of users.

6. The method of claim 1, wherein the transmitting of information in the database occurs at a pre-determined time after the request from a computer identified as being associated with a particular user.

7. The method of claim 1, wherein access is granted to the patient information to the plurality of users.

8. A dental case management system comprising:
a database of information comprising:
user information indicative of a plurality of users;
dental patient information indicative of a plurality of dental patients, to which access is granted to at least one of the users; and
case information indicative of a plurality of dental cases, each dental case relating to a single patient and to which access is granted to selected ones of the users; and
software executed by a processor for:
identifying a computer as being associated with a particular user; and
providing access to database information to which access is granted to the particular user.

9. The dental case management system of claim 8, further comprising:
a plurality of case folders comprising, for each case folder, a collection of links to information in the database related to a single case.

10. The dental case management system of claim 9, further comprising:
a plurality of patient folders, comprising:
for each patient folder, a collection of links to information in the database relating to a single patient; and
for each patient folder, a collection of links to all case folders related to that patient.

11. A program storage device storing instructions that when executed perform a method of managing cases, the method comprising:
storing user information indicative of a plurality of users;
storing patient information indicative of a plurality of patients;
storing case information indicative of a plurality of cases, each case relating to a single patient and selected ones of the users;
storing permissions information indicative of a plurality of permissions, each permission being associated with a selected one of the users and at least a portion of the patient information or case information;
identifying a computer as being associated with a particular user; and
in response to a request from a computer identified as being associated with a particular user, transmitting particular information in the database for which a permission is stored associated with the particular user and the particular information.

12. A case management system comprising:
means for storing user information indicative of a plurality of users;
means for storing patient information indicative of a plurality of patients to which access is granted to a selected one of the users;
means for storing case information indicative of a plurality of cases, each case relating to a single patient and to which access is granted to selected ones of the users;
means for indentifying a computer as being associated with a particular user; and
means for, in response to a request from the computer identified as being associated with a particular user, transmitting information to which access is granted to the particular user.
